(19) United States
(12) Patent Application Publication
(10) Pub. No.: US 2015/0278716 A1
(43) Pub. Date: Oct. 1, 2015

(54) RESERVATION ASSISTANCE METHOD

(71) Applicant: PANASONIC INTELLECTUAL PROPERTY CORPORATION OF AMERICA, Torrance, CA (US)

(72) Inventor: KOTARO SAKATA, Osaka (JP)

(21) Appl. No.: 14/656,396

(22) Filed: Mar. 12, 2015

(30) Foreign Application Priority Data
Mar. 28, 2014 (JP) 2014-068662

(51) Int. Cl. G06Q 10/02

(52) U.S. Cl. CPC G06Q 10/02

(57) ABSTRACT

A method includes: obtaining user schedule information having events of a user registered by time and date, facility schedule information having available time of a facility providing predetermined service registered therein, and information indicating correspondence relationship of a predetermined event out of the events and the facility; detecting first available time that is before time and date of the predetermined event and also after a current clock time using the user schedule information; detecting a common time period between the first available time and second available time that is available time of a first facility corresponding to the predetermined event using the facility schedule information and the information indicating correspondence relationship; making a primary reservation of the facility in the common time period for the user; generating presentation information being to present the primary reservation to the user; and sending the presentation information to a terminal device of the user.

### BACKGROUND

1. Technical Field

The present disclosure relates to a reservation assistance method to assist a user to make a reservation to a service provider.

2. Description of the Related Art

Conventionally, there are known systems where a user reserves a hairdresser (an example of a service provider) online (for example, refer to Japanese Unexamined Patent Application Publication No. 2001-344492).

### SUMMARY

However, further improvement has been required for Japanese Unexamined Patent Application Publication No. 2001-344492 above.

In one general aspect, the techniques disclosed here feature a reservation assistance method including: obtaining user schedule information that has a plurality of events of a user registered by time and date, facility schedule information that has available time of a facility providing predetermined service registered therein, and information that indicates correspondence relationship of a predetermined event out of the plurality of events and the facility; detecting first available time that is before time and date of the predetermined event and also after a current clock time using the user schedule information; detecting a common time period between the first available time and second available time that is available time of a first facility corresponding to the predetermined event using the facility schedule information and the information that indicates correspondence relationship; making a primary reservation of the facility in the common time period for the user; generating presentation information that is to present the primary reservation to the user; and sending the presentation information to a terminal device of the user.

These general and specific aspects may be implemented using a system, a method, and a computer program, and any combination of systems, methods, and computer programs.

According to the above aspect, it is possible to achieve further improvement.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIGS. 1A to 1C are diagrams illustrating an outline of a reservation assistance system according to an embodiment of the present disclosure;

FIG. 2 is a block diagram illustrating an example of a configuration of a reservation assistance system according to an embodiment of the present disclosure;

FIG. 3 is a flow chart illustrating an example of behaviors of a server device according to an embodiment of the present disclosure;

FIG. 4 is a chart illustrating an example of facility schedule information according to an embodiment of the present disclosure;

FIG. 5 is a chart illustrating an example of user schedule information according to an embodiment of the present disclosure;

FIGS. 6A and 6B are diagrams illustrating display examples of presentation information according to an embodiment of the present disclosure;

FIG. 7 is a diagram illustrating an example of a hardware configuration of a computer that achieves functions of an apparatus and a server device according to an embodiment of the present disclosure by software;

FIG. 8 is a diagram illustrating service class 1 (private data center type);

FIG. 9 is a diagram illustrating service class 2 (IaaS utilization type);

FIG. 10 is a diagram illustrating service class 3 (PaaS utilization type); and

FIG. 11 is a diagram illustrating service class 4 (SaaS utilization type).

### DETAILED DESCRIPTION

### Underlying Knowledge Forming Basis of the Present Disclosure

The present inventor has found that the following problems occur in the technique described in Japanese Unexamined Patent Application Publication No. 2001-344492 above.

In the system of Japanese Unexamined Patent Application Publication No. 2001-344492, firstly, a user accesses a website of a beauty parlor using a terminal device. Then, the user confirms availability of each hairdresser published in the website and sends reservation information specifying a desired hairdresser and time desired to receive treatment to a terminal device of a beauty parlor. The contents of the reservation information are confirmed at the beauty parlor using the terminal device, and when it is possible to satisfy the desire of the user, information of accepting the reservation is sent to the terminal device of the user. Thus, it is possible to reserve the hairdresser and the time desired by the user. However, when a user desires to receive treatment in advance in preparation for a predetermined event (for example, wedding ceremony and the like), for example, there are following problems. That is, in the conventional technique above, a user is required to carry out an operation to access a website for reservation, and there is a case where the above operation is forgotten as a result of postponing the operation when, for example, there are some days before the event. As a result, there used to be problems that there is a risk of not being able to make a reservation at the desired time and date as a predetermined period before the event is fully reserved.

Therefore, the present inventor has reviewed the following improvements to solve the above problems.

(1) A reservation assistance method in an aspect of the present disclosure includes: obtaining user schedule information that has a plurality of events of a user registered by time and date, facility schedule information that has available time of a facility providing predetermined service registered therein, and information that indicates correspondence relationship of a predetermined event out of the plurality of events and the facility; detecting first available time that is before time and date of the predetermined event and also after a current clock time using the user schedule information; detecting a common time period between the first available time and second available time that is available time of a first facility corresponding to the predetermined event using the facility schedule information and the information that indicates correspondence relationship; making a primary reservation of the facility in the common time period for the user; generating presentation information that is to present the primary reservation to the user; and sending the presentation information to a terminal device of the user.

According to the present aspect, it is possible that a user reserves a facility in advance in preparation for an event without carrying out an operation to make a reservation.

(2) In the above aspect, when a cancellation request for the primary reservation is received from the terminal device of the user, the primary reservation may be cancelled.

According to the present aspect, it is possible that a user cancels an unintended reservation.

(3) In the above aspect, when an agreement request for the primary reservation is received from the terminal device of the user, non-provisional reservation may be made to the facility in the time period.

According to the present aspect, it is possible that a user reserves a facility by certainly reflecting his or her own intention.

(4) In the above aspect, busy time information that illustrates a period of busy time of the facility may be obtained, and the first available time may be detected from the user schedule information except for the period illustrated by the busy time information using the busy time information.

According to the present aspect, available time of a user is detected except for busy time of the facility, so that it is possible that the user certainly reserves the facility.

(5) In the above aspect, the first available time may be detected from the user schedule information based on at least any of a day of week or a time period that is specified by the user.

According to the present aspect, a day of week or a time period that is specified in advance by a user is detected as available time of the user, so that it is possible that the user reserves the facility at the particularly desired time and date.

(6) In the above aspect, the facility schedule information may correspond to each of the facility or an area where the facility is located, first facility schedule information corresponding to a facility that is specified by the user or a facility located in an area that is specified by the user may be obtained, and the common time period may be detected based on the first facility schedule information.

According to the present aspect, it is possible that a user reserves a facility that is specified in advance by herself or himself or a facility located in an area that is specified in advance by herself or himself.

(7) In the above aspect, a first event that is registered in the user schedule information and indicates that the user has received predetermined service out of events before the current clock time may be detected, a second event that is registered in the user schedule information and is after time and date of the first event and also before the current clock time may be detected, a combination of the first event and the second event may be stored, when a third event that is registered in the user schedule information and of a type same as the second event after the current clock time is detected, second facility schedule information corresponding to a facility that provides service illustrated by the first event may be obtained based on the combination, and the common time period may be detected using the second facility schedule information and the user schedule information.

According to the present aspect, regarding an event registered in a schedule, once a user receives predetermined service, it is possible that the user reserves a facility to receive the predetermined service without reserving by herself or himself when a similar event is registered in the schedule next time.

(8) In the above aspect, when the predetermined event is cancelled in the user schedule information, the primary reservation may be cancelled.

According to the present aspect, in association with cancellation of a predetermined event, a reservation to the facility corresponding to the predetermined event is cancelled.

(9) In the above aspect, reservation time and date in the common time period may be determined in accordance with the event.

According to the present aspect, the facility is reserved in a time period most appropriate for the event.

(10) In the above aspect, the facility that provides the predetermined service may be a beauty parlor.

According to the present aspect, it is possible that a user reserves a beauty parlor in advance in preparation for an event without carrying out an operation to make a reservation.

Detailed descriptions are given below to embodiments of the present disclosure with reference to the drawings.

### <Overall Picture of Service to be Provided>

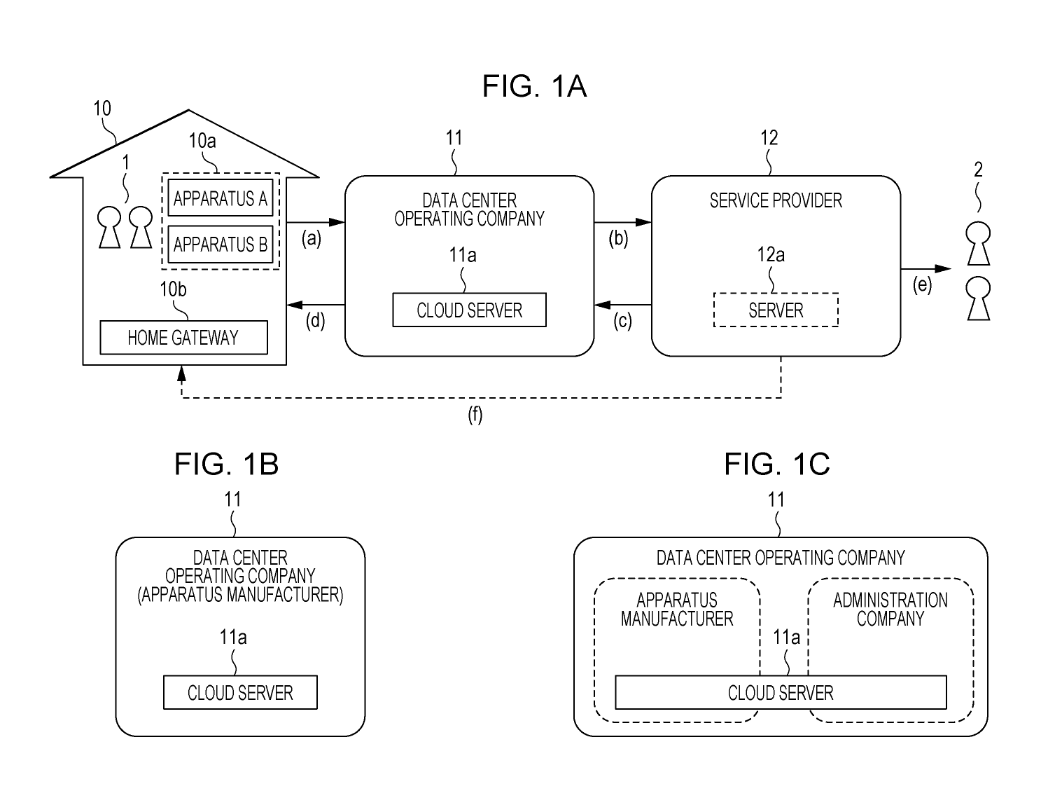

Firstly, descriptions are given to an overall picture of service to be provided according to the present embodiment using FIGS. 1A to 1C. FIGS. 1A to 1C are diagrams illustrating an outline of a reservation assistance system in the present embodiment. FIG. 1A illustrates an overall picture of a reservation assistance system in the present embodiment.

A group 10 is, for example, an enterprise, an organization, a household, and the like and its size does not matter. In the group 10, an apparatus A and an apparatus B, which are a plurality of apparatuses 10a (for example, an apparatus 100 described later), and a home gateway 10b are present.

The plurality of apparatuses 10a are apparatuses capable of connecting to the Internet (for example, a smartphone, a tablet, a PC, a TV, and the like). It should be noted that the plurality of apparatuses 10a may be, even not capable of connecting to the Internet by itself, apparatuses that become capable of connecting to the Internet via the home gateway 10b. In addition, in the group 10, a user 1 that uses the plurality of apparatuses 10a is present. The user 1 is, for example, an employee of a service providing facility (for example, a beauty parlor) or its client.

In a data center operating company 11, a cloud server 11a is present. The cloud server 11a is a virtual server cooperating with various apparatuses via the Internet. The data center operating company 11 carries out data administration, administration of the cloud server 11a, operation of a data center that carries out them, and the like. Services carried out by the data center operating company 11 are described later in detail.

Here, the data center operating company 11 is not limited to a company that carries out only data administration, operation of the cloud server 11a, or the like. For example, when an apparatus manufacturer that develops and manufactures one apparatus of the plurality of apparatuses 10a carries out data administration, administration of the cloud server 11a, and the like, the apparatus manufacturer falls under the data center operating company 11 (refer to FIG. 1B).

In addition, the data center operating company 11 is not limited to one company. For example, when an apparatus manufacturer and a separate administration company carry out data administration and operation of the cloud server 11a in cooperation or by sharing, both or either one falls under the data center operating company 11 (refer to FIG. 1C).

A service provider 12 possesses a server 12a (for example, a server device 200 described later). The server 12a may be plural depending on the purpose.

In the above service, the home gateway 10b is not strictly necessary. For example, when the cloud server 11a carries out all of the data administration, the home gateway 10b becomes not necessary. There is also a case where there are no apparatus that is not capable of connecting to the Internet by itself such as a case where all apparatuses in the group 10 are connected to the Internet.

Next, a flow of information in the above service is described. Firstly, the apparatus A or the apparatus B of the group 10 respectively sends information (for example, user schedule information, facility schedule information, and the like described later) to the cloud server 11a of the data center operating company 11. The cloud server 11a accumulates the information of the apparatus A or the apparatus B ((a) in FIG. 1A).

The above information may also be provided from the plurality of apparatuses 10a themselves directly to the cloud server 11a via the Internet. Alternatively, the above information may also be accumulated from the plurality of apparatuses 10a to the home gateway 10b once to provide the information from the home gateway 10b to the cloud server 11a.

Next, the cloud server 11a of the data center operating company 11 provides the accumulated information to the service provider 12 in a constant unit. Here, the constant unit may be a unit that the data center operating company 11 is capable of organizing the accumulated information to provide it to the service provider 12, and may also be a unit requested by the service provider 12. Although described as a constant unit, it may also be not constant and the amount of provided information may also vary depending on the situation.

The information accumulated in the cloud server 11a is stored in the server 12a possessed by the service provider 12 as needed ((b) in FIG. 1A). Then, the service provider 12 organizes the stored information into information adapted to service to be provided to a user (for example, reservation instruction information, presentation information, and the like described later) to provide it to the user. The user to provide may be the user 1 that uses the plurality of apparatuses 10a and may also be a user 2 outside the group 10.

A method of providing service to a user may provide, for example, service from the service provider 12 directly to the user ((f) and (e) in FIG. 1A). In addition, the method of providing service to a user may provide, for example, service to the user again through the cloud server 11a of the data center operating company 11 ((c) and (d) in FIG. 1A). Still in addition, the cloud server 11a of the data center operating company 11 may also organize the accumulated information into information adapted to service to be provided to a user to provide it to the service provider 12.

The user 1 and the user 2 may be separated and may also be same.

### <Configuration of Reservation Assistance System>

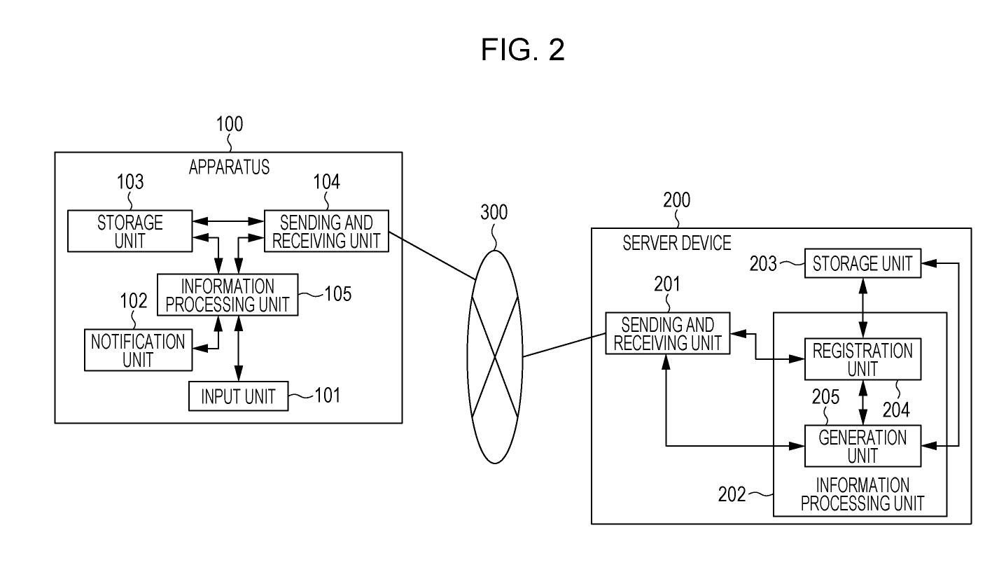

Next, descriptions are given to a configuration example of a reservation assistance system according to the present embodiment using FIG. 2. FIG. 2 is a block diagram illustrating an example of a configuration of a reservation assistance system in the present embodiment.

As illustrated in FIG. 2, the reservation assistance system has an apparatus 100 and a server device 200.

In FIG. 2, the apparatus 100 and the server device 200 are connected via a network 300. The network 300 may be a wireless network, may also be a wired network, and may also be a network in which a wired network and a wireless network are mixed.

In addition, although only one apparatus 100 is illustrated in FIG. 2, it is considered that there are two or more of it. In the present embodiment, there are an apparatus 100 to be used by a service provider and an apparatus 100 to be used by a user. The service provider is an employee that works for the service providing facility. Hereinafter, descriptions are given to an example where the service providing facility is a beauty parlor and the service provider is a hairdresser. In the descriptions below, employees and the like of the beauty parlor are collectively described as “a hairdresser”. In addition, in the descriptions below, the apparatus 100 to be used by the service provider is called as “the apparatus 100 of a hairdresser” and the apparatus 100 to be used by the user is called as “the apparatus 100 of a user”.

Firstly, a configuration of the apparatus 100 is described.

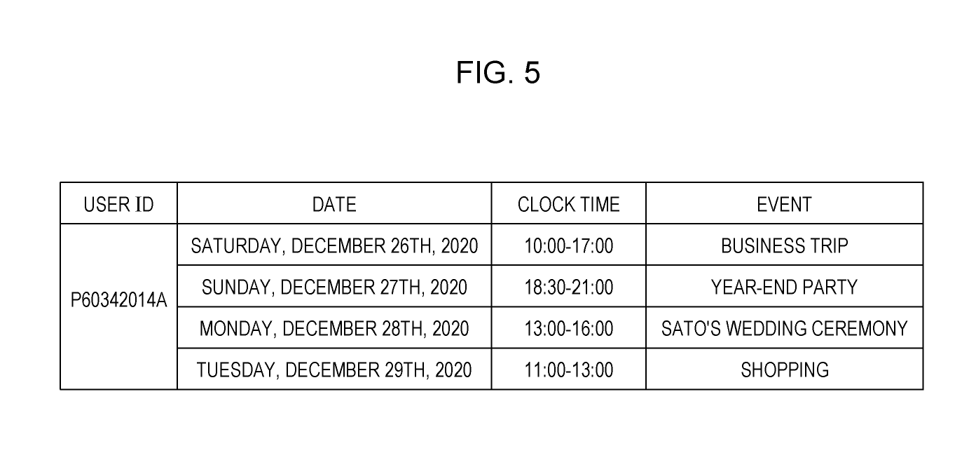

The apparatus 100 is an information processing device (terminal device) that is capable of utilizing reservation assistance service provided by the server device 200 and is, for example, a smartphone, a tablet, a PC, a TV, and the like. The reservation assistance service is service to perform a reservation to a beauty parlor, when a user registers a predetermined event in schedule information, so as to receive treatment before the above event without requiring a reservation operation of the user (hereinafter, referred to as automatic reservation). The schedule information (hereinafter, referred to as user schedule information) is, for example, information of an application in which the user is capable of arbitrarily registering an event and the like by time and date (for example, a scheduler, a calendar application, a diary application, and the like). Details of the user schedule information are described later using FIG. 5.

The apparatus 100 is provided with an input unit 101, a notification unit 102, a storage unit 103, a sending and receiving unit 104, and an information processing unit 105.

The input unit 101 is an input device, such as buttons and a touch screen.

For example, in the case of the apparatus 100 of a user, the input unit 101 accepts an input operation of user schedule information and the like by the user.

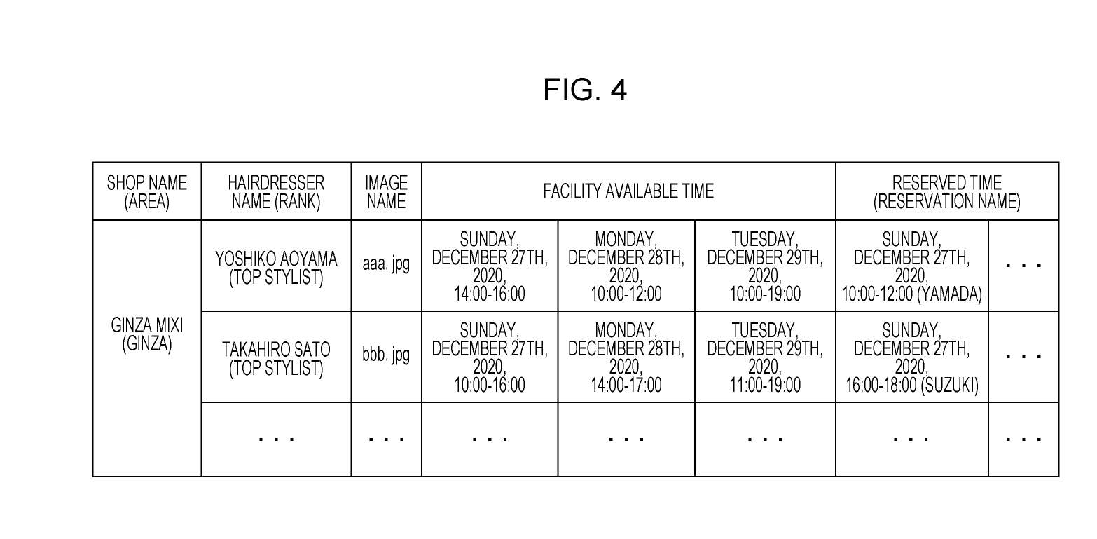

In addition, in the case of the apparatus 100 of a hairdresser, for example, the input unit 101 accepts an input operation of facility schedule information and the like by the hairdresser. The facility schedule information is information that illustrates available time that a user is able to receive treatment at a predetermined beauty parlor. For example, the facility schedule information includes information of available time of each hairdresser that is registered by the hairdresser. Details of the facility schedule information are described later using FIG. 4.

The notification unit 102 is a display device, such as a display, or an output device, such as a speaker.

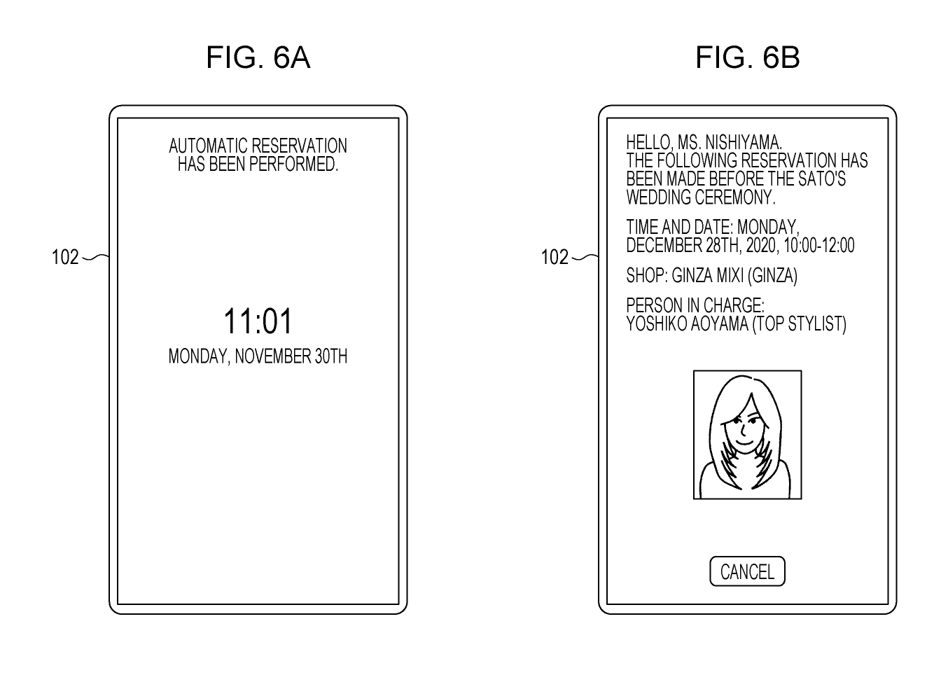

For example, in the case of the apparatus 100 of a user, the notification unit 102 carries out display of presentation information. The presentation information is information sent from the server device 200 to the apparatus 100 of a user and includes information of the automatic reservation being performed and details of the automatic reservation (for example, time and date, shop, hairdresser, and the like). A display example of the presentation information is described later using FIGS. 6A and 6B.

The storage unit 103 is a storage device, such as a memory and a hard disk device.

For example, in the case of the apparatus 100 of a user, the storage unit 103 stores the user schedule information registered by the user. The storage unit 103 stores the presentation information received from the server device 200.

In addition, in the case of the apparatus 100 of a hairdresser, for example, the storage unit 103 stores the facility schedule information registered by the hairdresser. Still in addition, the storage unit 103 stores reservation instruction information received from the server device 200. The reservation instruction information is information sent from the server device 200 to the apparatus 100 of a hairdresser and includes information of instruction of performing automatic reservation and details of the automatic reservation (for example, time and date, name of person who made the reservation, and the like).

In addition, in the case of the apparatus 100 of a hairdresser, for example, the storage unit 103 stores image information of a hairdresser (details are described later). The image information of a hairdresser is stored in association with the image name included in the facility schedule information.

The sending and receiving unit 104 is a communication interface unit that sends information to another device and receives information sent by another device.

For example, in the case of the apparatus 100 of a user, the sending and receiving unit 104 sends the user schedule information to the server device 200 per predetermined time or by an operation of a user. The sending and receiving unit 104 also receives the presentation information from the server device 200.

In addition, in the case of the apparatus 100 of a hairdresser, for example, the sending and receiving unit 104 sends the facility schedule information and the image information of a hairdresser (associated with an image name included in the facility schedule information) per predetermined time or by an operation of a hairdresser to the server device 200. The sending and receiving unit 104 also receives the reservation instruction information from the server device 200.

The information processing unit 105 is a control device, such as a processor that performs a variety of information processing.

For example, in the case of the apparatus 100 of a user, the information processing unit 105 reads the user schedule information from the storage unit 103 per predetermined time or by an operation of a user and causes the sending and receiving unit 104 to perform sending to the server device 200. In addition, the information processing unit 105 once causes the storage unit 103 to store the presentation information received by the sending and receiving unit 104 from the server device 200, reads the presentation information from the storage unit 103 at a predetermined timing, and causes the notification unit 102 to display.

In addition, in the case of the apparatus 100 of a hairdresser, for example, the information processing unit 105 reads the facility schedule information from the storage unit 103 per predetermined time or by an operation of a hairdresser and causes the sending and receiving unit 104 to perform sending to the server device 200. The information processing unit 105 also once causes the storage unit 103 to store the reservation instruction information received by the sending and receiving unit 104 from the server device 200, reads the reservation instruction information from the storage unit 103 at a predetermined timing, and performs the automatic reservation. For example, the information processing unit 105 performs automatic reservation by registering detailed information on automatic reservation included in the reservation instruction information in the facility schedule information stored in the storage unit 103. Details of performing the automatic reservation are described later using FIG. 4.

In the above description, the configuration of the apparatus 100 has been described.

Next, a configuration of the server device 200 is described.

The server device 200 is an information processing device that achieves reservation assistance service by generating presentation information and reservation instruction information based on the user schedule information, the facility schedule information, and the like from the apparatuses 100, sending the reservation instruction information to the apparatus 100 of a hairdresser, and sending the presentation information to the apparatus 100 of a user.

The server device 200 is provided with a sending and receiving unit 201, an information processing unit 202, and a storage unit 203.

The sending and receiving unit 201 is a communication interface unit to send information to another device and receive information sent from another device.

For example, the sending and receiving unit 201 receives the user schedule information from the apparatus 100 of a user and receives the facility schedule information and the image information of a hairdresser from the apparatus 100 of a hairdresser.

In addition, for example, the sending and receiving unit 201 sends the presentation information generated in a generation unit 205 to the apparatus 100 of a user and sends the reservation instruction information generated in the generation unit 205 to the apparatus 100 of a hairdresser.

The information processing unit 202 is a control device, such as a processor that performs a variety of information processing. The information processing unit 202 is provided with a registration unit 204 and the generation unit 205.

Firstly, the registration unit 204 is described.

For example, the registration unit 204 registers the user schedule information received by the sending and receiving unit 201 from the apparatus 100 of a user in the storage unit 203.

In addition, for example, the registration unit 204 registers the facility schedule information and the image information of a hairdresser received by the sending and receiving unit 201 from the apparatus 100 of a hairdresser in the storage unit 203.

Next, the generation unit 205 is described.

For example, as registration of the user schedule information is carried out by the registration unit 204, the generation unit 205 reads the user schedule information and the facility schedule information from the storage unit 203.

Then, firstly, the generation unit 205 detects a predetermined event registered in the user schedule information. Here, the detected event is an event planned in a predetermined period t1 after the current clock time. The predetermined period t1 is, for example, for six months, three months, one month, two weeks, one week, three days, or the like, and is not limited to them.

Next, the generation unit 205 detects available time not less than a predetermined period t3 (t2>t3) out of a predetermined period t2 (t1>t2) before the time and date of the detected event in the user schedule information. The available time is a time period in which no event is registered. Here, the detected available time is referred to as “user available time” in the descriptions below. The predetermined period t2 is, for example, for one month, two weeks, one week, three days, one day, 12 hours, six hours, three hours, or the like, and is not limited to them. The predetermined period t3 is, for example, approximate time taken for treatment of a hairdresser and is two hours and the like, and is not limited to this. The above predetermined periods t1 through t3 are set by, for example, an administrator or the like of the server device 200 or by a user in advance.

Next, the generation unit 205 detects a common time period between the detected user available time and available time of the beauty parlor registered in the facility schedule information (hereinafter, referred to as facility available time). Here, the detected time period is referred to as “common available time” in the descriptions below.

Next, the generation unit 205 generates reservation instruction information and causes the sending and receiving unit 201 to perform the sending. As described above, the reservation instruction information is information to give an instruction of performing of automatic reservation to the apparatus 100 of a hairdresser and includes information on details of the automatic reservation (for example, the time and date of the common available time, a name of a person who made the reservation, and the like).

Next, the generation unit 205 generates the presentation information and causes the sending and receiving unit 201 to perform the sending. As described above, the presentation information is information to notify the user of the automatic reservation being performed and includes information on details of the automatic reservation (for example, the time and date of the common available time, a shop name, a name of a hairdresser in charge, and the like).

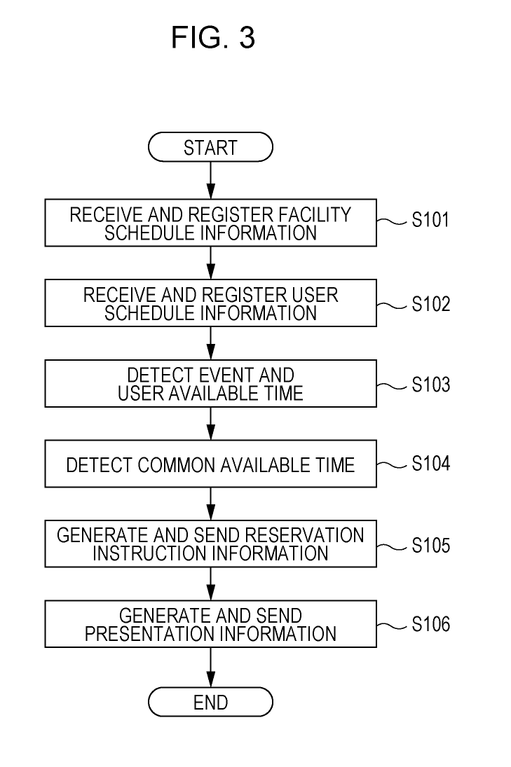

Details of each process in the generation unit 205 described above are described later using a flow in FIG. 3.

The storage unit 203 is a storage device, such as a memory and a hard disk device.

For example, the storage unit 203 stores the user schedule information registered in the registration unit 204.

For example, the storage unit 203 stores the facility schedule information and the image information of a hairdresser registered by the registration unit 204.

In addition, for example, the storage unit 203 stores template information of the presentation information. The template information includes, for example, text information of a fixed phrase, image information of buttons accepting an operation of a user, and the like (details are described later).

In the above description, the configuration of the server device 200 has been described.

### <Behaviors of Server Device 200>

Next, descriptions are given to a behavioral example of the server device 200 of the reservation assistance system according to the present embodiment using FIG. 3. FIG. 3 is a flow chart illustrating a behavioral example of the server device 200 in the present embodiment.

In step S101, the sending and receiving unit 201 receives facility schedule information from the apparatus 100 of a hairdresser. Then, the registration unit 204 registers the facility schedule information in the storage unit 203.

Here, descriptions are given to an example of the facility schedule information using FIG. 4. FIG. 4 is an example of facility schedule information registered in the storage unit 203.

As illustrated in FIG. 4, the facility schedule information includes each information item of a shop name (area), a hairdresser name (rank), an image name, and facility available time.

The shop name (area) is a name of a beauty parlor that a hairdresser works for and an area where the beauty parlor is located.

The hairdresser name (rank) is a name of a hairdresser and a rank of the hairdresser. The rank includes, for example, a director, a top stylist, a stylist, an assistant, and the like.

The image name is a name (identification information) of image information of a hairdresser. The image information of a hairdresser may be, for example, a picture of the face or the upper body of the hairdresser and may also be a portrait and the like of the hairdresser. As described above, the image information of the hairdresser is stored in the storage unit 103 of the apparatus 100 of a hairdresser in association with an image name, sent from the apparatus 100 of a hairdresser together with the facility schedule information to the server device 200, and stored in the storage unit 203.

The facility available time is available time (time and date with no reservation) of each hairdresser. In the example of FIG. 4, the facility available time is registered with year (A.D.), month, day, and clock time.

Reserved time (reservation name) is reserved time (time and date with a reservation) of each hairdresser and a name of the user who made the reservation. In the example of FIG. 4, the reserved time is registered with year (A.D.), month, day, and clock time. Registration of the reserved time (reservation name) is, other than carried out by a direct input by the hairdresser using the apparatus 100, also carried out by performing automatic reservation based on the reservation instruction information.

In the above description, one example of the facility schedule information has been described. The description goes back to the flow of FIG. 3.

In step S102, the sending and receiving unit 201 receives the user schedule information from the apparatus 100 of a user. Then, the registration unit 204 registers the user schedule information in the storage unit 203.

Here, descriptions are given to an example of the user schedule information using FIG. 5. FIG. 5 is a chart illustrating an example of the user schedule information registered in the storage unit 203. FIG. 5 illustrates, as an example, schedule information for four days from Dec. 26th to Dec. 29th in 2020.

As illustrated in FIG. 5, the user schedule information includes each information item of a user ID, date, clock time, and an event.

The user ID is an ID capable of identifying a user that is a user of the apparatus 100 and is capable of utilizing the reservation assistance service. The user ID is, for example, stored in the storage unit 203 in advance in association with a name of a user. Although a user ID is used here, a name of the user may also be used.

The date and the clock time are the time and date when an event described later is planned. In the example of FIG. 5, the date is registered with a year (A.D.), a month, a day, and a day of week.

The event is an activity plan of the user registered corresponding to the date and the clock time. While the details are described later, a predetermined event is detected by the generation unit 205 out of the events registered as illustrated in FIG. 5. In addition, the date and the clock time with no event registered in FIG. 5 are detected as user available time by the generation unit 205.

In the above description, one example of the user schedule information has been described. The description goes back to the flow of FIG. 3.

In step S103, as user schedule information is registered in the storage unit 203, the generation unit 205 reads the user schedule information from the storage unit 203. Then, the generation unit 205 detects the predetermined event and the user available time based on the user schedule information.

Here, using FIG. 5, descriptions are given to an example of process of detecting an event and user available time.

Firstly, the generation unit 205 detects a predetermined event based on a keyword set in advance out of the events registered in the predetermined period t1 after the current clock time in the user schedule information in FIG. 5. Here, descriptions are given to an example where the predetermined period t1 is set as one month and the current clock time is at 11 o'clock on Monday, Nov. 30, 2020 (hereinafter, the description of A.D. is omitted). In this case, firstly, the generation unit 205 carries out known text analysis process and the like out of the events registered during one month from 11 o'clock on November 30th to 11 o'clock on December 30th and detects an event including a keyword that is set in advance. Here, the keyword set in advance is text information that indicates an event having a high possibility that a user goes to a beauty parlor in advance, and includes, for example, “wedding ceremony”, “coming of age ceremony”, “alumni reunion”, and the like. The keyword is set in advance by, for example, an administrator and the like of the server device 200 or by the user. In FIG. 5, for example, an event “Sato's wedding ceremony” is detected.

Next, the generation unit 205 detects available time not less than the predetermined period t3 out of the predetermined period t2 before the time and date of the detected event as the user available time in the user schedule information in FIG. 5. For example, when the detected event is “Sato's wedding ceremony”, the predetermined period t2 is set at six hours, and the predetermined period t3 is set at two hours, the generation unit 205 behaves as follows. That is, the generation unit 205 detects time when no event is registered for two hours or more between 7 o'clock and 13 o'clock on December 28th. In FIG. 5, the time period from 7 o'clock to 13 o'clock on December 28th is detected as the user available time.

In the above description, one example of the process of detecting an event and user available time has been described. The description goes back to the flow of FIG. 3.

In step S104, the generation unit 205 reads the facility schedule information from the storage unit 203. Then, the generation unit 205 detects a common time period between the detected user available time and the facility available time registered in the facility schedule information as the common available time.

A combination of an event and a service provider (may also be a service providing facility) of a reservation destination is set in advance by an administrator and the like of the server device 200 or by the user. For example, when a combination of an event “wedding ceremony” and a service provider “hairdresser” is set in advance and the detected event is “wedding ceremony”, the generation unit 205 reads the facility schedule information of “hairdresser” from the storage unit 203 in step S104.

Here, using FIG. 4, an example of process of detecting common available time is described.

Firstly, the generation unit 205 detects a time period in common (overlapping) with the user available time out of the facility available time registered in the facility schedule information in FIG. 4. For example, when the user available time is from 7 o'clock to 13 o'clock on December 28th, from 10 o'clock to 12 o'clock on December 28th is detected as the common available time out of a plurality of facility available times illustrated in FIG. 4.

In the above description, one example of the process of detecting common available time has been described. The description goes back to the flow of FIG. 3.

In step S105, the generation unit 205 generates the reservation instruction information and causes the sending and receiving unit 201 to perform sending of the reservation instruction information to the apparatus 100 of a hairdresser.

Here, using FIGS. 4 and 5, an example of process of generating reservation instruction information is described.

Firstly, the generation unit 205 extracts information of a user ID from the user schedule information in FIG. 5. In the example of FIG. 5, a user ID “P60342014A” is extracted. Then, the generation unit 205 reads a user name associated with the extracted user ID from the storage unit 203. Here, a user name “Nishiyama” is read out.

Next, the generation unit 205 extracts each information item of facility available time detected as the common available time and a hairdresser name (rank) associated with the facility available time from the facility schedule information in FIG. 4. In the example of FIG. 4, facility available time “Monday, Dec. 28, 2020, 10:00-12:00” and a hairdresser name (rank) “Yoshiko Aoyama (top stylist)” are extracted.

Next, the generation unit 205 generates reservation instruction information that includes each information item of the read user name and the extracted facility available time and hairdresser name (rank) and gives an instruction of performing automatic reservation to the apparatus 100 of a hairdresser. For example, the reservation instruction information has contents to give an instruction of reservation to carry out treatment to Nishiyama by a top stylist Yoshiko Aoyama from 10 o'clock to 12 o'clock on Monday, Dec. 28th, 2020. While the example of including the user name in the reservation instruction information is taken here, a user ID may also be included (same in each modification described later).

In the above description, one example of the process of generating reservation instruction information has been described. Out of the detected common available time, it is desired to determine the reservation time and date in accordance with an event. For example, it is desired to reserve a beauty parlor on the day of the event for “wedding ceremony” and “coming of age ceremony” and several days before including the day of the event for “alumni reunion”.

Here, using FIG. 4, descriptions are given to an example of process of performing automatic reservation in the apparatus 100 of a hairdresser.

In the apparatus 100 of a hairdresser, as the sending and receiving unit 104 receives the reservation instruction information from the server device 200, the information processing unit 105 once causes the storage unit 103 to store it. Then, the information processing unit 105 reads the reservation instruction information and the facility schedule information in FIG. 4 from the storage unit 103 at a predetermined timing.

Next, the information processing unit 105 registers the user name and the facility available time included in the reservation instruction information in the reserved time (reservation name) in association with a hairdresser name (top stylist) included in the reservation instruction information in the facility schedule information in FIG. 4. Although not shown in the drawing, for example, “Monday, Dec. 28, 2020, 10:00-12:00 (Nishiyama)” is registered in the reserved time (reservation name) in association with the hairdresser name (rank) “Yoshiko Aoyama (top stylist)”. In addition, the information processing unit 105 deletes “Monday, Dec. 28, 2020, 10:00-12:00” in the facility available time associated with the hairdresser name (rank) “Yoshiko Aoyama (top stylist)”.

In the above description, an example of the process of performing automatic reservation in the apparatus 100 of a hairdresser has been described. The description goes back to the flow of FIG. 3.

In step S106, the generation unit 205 generates presentation information and causes the sending and receiving unit 201 to perform sending of the presentation information to the apparatus 100 of a user.

Here, an example of process of generating presentation information is described using FIGS. 4 and 5.

Firstly, the generation unit 205 extracts information of the detected event “Sato's wedding ceremony” from the user schedule information in FIG. 5.

Next, the generation unit 205 extracts each information item of the shop name (area) and the image name associated with the hairdresser name (rank) extracted by the process in step S105 from the facility schedule information in FIG. 4. In the example of FIG. 4, a shop name (area) “Ginza MIXI (Ginza)” and an image name “aaa.jpg” are extracted.

Next, the generation unit 205 reads the image information of a hairdresser associated with the image name “aaa.jpg” and the template information of the presentation information from the storage unit 203.

Next, the generation unit 205 generates image information including each information item of the event, the shop name (area), and the image name extracted at this time, the user name read from the storage unit 203 when generating the reservation instruction information, each information item of the facility available time and the hairdresser name (rank) extracted from the facility schedule information, and the image information of a hairdresser read from the storage unit 203 in the template information of the presentation information read from the storage unit 203. The image information is presentation information to notify the user of the automatic reservation being performed and details of the reservation. A method of sending presentation information may include, for example, an email.

In the above description, one example of the process of generating presentation information has been described.

The above presentation information is received in the apparatus 100 and displayed. Since the process of displaying presentation information in the apparatus 100 is already described, the description is omitted here.

Here, using FIGS. 6A and 6B, descriptions are given to a display example of the presentation information in the apparatus 100. FIG. 6A illustrates a display example when receiving the presentation information in the apparatus 100, and FIG. 6B illustrates a display example of the presentation information in the apparatus 100.

As illustrated in FIG. 6A, when the apparatus 100 receives the presentation information, a notification message of “Automatic reservation has been performed.” is displayed on, for example, top of the notification unit 102. Then, as the user carries out an operation to give an instruction of display of the presentation information, the presentation information illustrated in FIG. 6B is displayed on the notification unit 102.

As illustrated in FIG. 6B, a message to inform that the reservation is performed before the event is displayed to the user on top of the notification unit 102. In addition, below the message, the time and date, the shop name (area), the hairdresser in charge (rank), and the image of the hairdresser are displayed as details of the reservation.

As illustrated in FIG. 6B, in a lower area of the notification unit 102, a “cancel” button is displayed. When intending to cancel the reservation, the user carries out an operation of the button. When the “cancel” button is operated, a cancellation request for the automatic reservation is sent from the apparatus 100 of a user to the server device 200. The server device 200 that has received the request sends an instruction of cancellation of the automatic reservation to the apparatus 100 of a hairdresser. The apparatus 100 of a hairdresser that has received the instruction deletes the time and date and the reservation name that are relevant from the reserved time (reservation name) of the facility schedule information. In addition, the apparatus 100 of a hairdresser registers the deleted time and date in the facility available time of the facility schedule information.

After receiving the above presentation information, the information processing unit 105 may also register detailed information on the automatic reservation included in the presentation information in the user schedule information stored in the storage unit 103.

In the above description, according to the present embodiment, it is possible that the user makes a reservation to a hairdresser in advance of the event only by registering the predetermined event in the schedule information without carrying out an operation to make a reservation. According to the present embodiment, it is possible that the beauty parlor increases the occupancy rate of the available time in the shop.

### <Modifications in Embodiment>

While the embodiment of the present disclosure has been described in the above description, the present disclosure may be variously modified within a scope without departing from the spirit. Descriptions are given below to modifications in the above embodiments.

### (First Modification)

While an example where the combination of an event “wedding ceremony” and a service provider of a reservation destination “hairdresser” is set in advance in the above embodiment has been described, the combination is not limited to this. Specific examples are described below.

For example, it is assumed that a combination of an event “business trip” and a service provider of a reservation destination “massage practitioner” is set. In this case, when detecting the event “business trip” from the user schedule information, the generation unit 205 reads the facility schedule information of the massage practitioner from the storage unit 203 to carry out automatic reservation to the massage practitioner based on that.

In addition, for example, it is assumed that a combination of an event “TOEFL®” and a service provider of a reservation destination “English teacher” is set. In this case, when detecting the event “TOEFL®” from the user schedule information, the generation unit 205 reads facility schedule information of an English teacher from the storage unit 203 and carries out automatic reservation to an English teacher based on that.

In addition, for example, it is assumed that a combination of an event “business trip to India” and two types of service providers “English teacher” and “Hindi teacher” of a reservation destination is set. In this case, when detecting the event “business trip to India” from the user schedule information, the generation unit 205 reads facility schedule information of “English teacher” and “Hindi teacher” from the storage unit 203 and carries out automatic reservation to “English teacher” and “Hindi teacher” based on that. In such a manner, a combination of a plurality of service providers may be set as reservation destinations to one event.

In addition, for example, it is assumed that a combination of an event “drive” and a service provider of a reservation destination “rent-a-car” is set. In this case, as detecting the event “drive” from the user schedule information, the generation unit 205 reads facility schedule information of the rent-a-car from the storage unit 203 and carries out automatic reservation of the rent-a-car based on that. In such a manner, the service provider of the reservation destination may also be a substance, not only a person or a business.

The combination of an event and a service provider of a reservation destination described above may also be appropriately changed (including addition and deletion) by an administrator and the like of the server device 200 or a user.

### (Second Modification)

The combination of an event and a service provider of a reservation destination described in the first modification may also be learnt by the server device 200. For example, firstly, the generation unit 205 detects a first event before the current clock time in the user schedule information read from the storage unit 203. The first event is assumed to be, for example, “treatment at beauty parlor”. Next, the generation unit 205 detects a second event after the time and date of the first event and also before the current clock time. The second event is assumed to be, for example, “trip”. Next, the generation unit 205 stores (sets) the first event “treatment at beauty parlor” and the second event “trip” as a new combination. In the descriptions later, the generation unit 205 carries out detection of an event and automatic reservation based on the above new combination. That is, when the event “trip” is detected in the predetermined period t1 after the current clock time from the newly read user schedule information, the generation unit 205 performs automatic reservation to a hairdresser as described in the above embodiment.

### (Third Modification)

Automatic reservation may also be carried out by avoiding busy time. For example, in the server device 200, the registration unit 204 registers busy time information obtained from a predetermined device or inputted directly to the server device 200 in the storage unit 203. The busy time information is information indicating periods of general busy time (for example, year-end and New Year season, long holiday season, before and after holidays, and the like). When at least a part of the period indicated by the busy time information overlaps the predetermined period t2, the generation unit 205 detects user available time in the predetermined period t2 except in the overlapped period. Thus, in the present modification, it is possible to perform automatic reservation by avoiding the busy time.

### (Fourth Modification)

On the contrary to the third modification, automatic reservation may also be carried out during the busy time. This is because it is considered that there may be a facility having more facility available time during the busy time among facilities. In this case, in the server device 200 for example, when at least a part of the period indicated by the busy time information overlaps the predetermined period t2, the generation unit 205 detects user available time in the overlapped period. Thus, it is possible to perform automatic reservation during busy time in the present modification.

### (Fifth Modification)

While the example of performing automatic reservation and then notifying a user of presentation information to indicating that is described in the above embodiment, automatic reservation may also be performed after notifying a user of the presentation information indicating that automatic reservation is possible (automatic reservation is proposed) and obtaining agreement of the user.

In this case, for example, the message becomes a sentence indicating that automatic reservation is possible in FIG. 6B. In addition, for example, in FIG. 6B, in addition to the “cancel” button, an “agreement” button and a “pending” button are displayed. When agreeing the notified automatic reservation, the user carries out an operation of the “agreement” button. When intending to withhold agreement of the notified automatic reservation, the user carries out an operation of the “pending” button.

When the “agreement” button is operated, a request to perform automatic reservation is sent from the apparatus 100 of a user to the server device 200. The server device 200 receiving the request sends the reservation instruction information described above to the apparatus 100 of a hairdresser. The apparatus 100 of a hairdresser registers facility available time and a user name included in the reservation instruction information in the facility schedule information of the storage unit 103.

When the “pending” button is operated, a request to withhold the automatic reservation is sent from the apparatus 100 of a user to the server device 200. The server device 200 receiving the request sends an instruction to withhold the automatic reservation, together with the reservation instruction information, to the apparatus 100 of a hairdresser. The apparatus 100 of a hairdresser provisionally registers the facility available time and the user name included in the reservation instruction information in the facility schedule information of the storage unit 103 (for example, set a flag indicating provisional registration). The provisionally registered information is deleted when an instruction to perform automatic reservation is not received from the server device 200 within a certain period (for example, for one week).

Then, when the user operates the “agreement” button within a certain period after the operation of the “pending” button, the request to perform automatic reservation is sent from the apparatus 100 of a user to the server device 200. The server device 200 receiving the request sends an instruction to perform the provisionally registered reservation to the apparatus 100 of a hairdresser. The apparatus 100 of a hairdresser receiving the instruction releases the provisional registration and changes into formal registration regarding the facility available time and the user name (reserved time and reservation name) provisionally registered in the facility schedule information.

### (Sixth Modification)

When the above event is deleted from the user schedule information after performing the automatic reservation based on a predetermined event and also before the time and date of the event, the generation unit 205 of the server device 200 may also give an instruction of cancellation of the performed automatic reservation to the apparatus 100 of a hairdresser. Thus, it is possible that the user cancels the already performed automatic reservation only by carrying out an operation of deleting the event from the user schedule information.

### (Seventh Modification)

While an example of storing the user schedule information in the storage unit 103 of the apparatus 100 of a user and storing the facility schedule information in the storage unit 103 of the apparatus 100 of a hairdresser is described in the above embodiment, it is not limited to this. For example, the user schedule information and the facility schedule information may also be stored in a predetermined device, not shown. In that case, the server device 200 obtains the user schedule information and the facility schedule information from the above predetermined device.

### (Eighth Modification)

The user may also specify a day of week and/or a time period that is desired to carry out automatic reservation in advance. In this case, the generation unit 205 detects user available time from the day of week and/or the time period that is specified by the user in addition to the predetermined periods t2 and t3 in the user schedule information. Thus, automatic reservation is made on the day of week and/or in the time period that is desired by the user, so that convenience of the user is improved.

### (Ninth Modification)

The user may also specify a shop or an area subjected to automatic reservation in advance. In this case, the generation unit 205 reads a facility schedule of the shop or the area that is specified in advance by the user out of the plurality of facility schedules stored for each shop or area in the storage unit 203 and carries out detection of the common available time based on the facility schedule information. Thus, since automatic reservation in the shop desired by the user or a shop in the area desired by the user is made, convenience of the user is improved. When detection of the common available time is carried out in the present modification, in the case that there is a plurality of candidates, it may be selected by the user and may also be selected by the shop closest to the current position of the user. In that case, the server device 200 obtains the current position of the user and positional information of the shop in advance to be registered in the storage unit 203.

### (Tenth Modification)

While the above embodiment takes an example when reservation process is carried out in the apparatus 100 of a hairdresser that has received an instruction from the server device 200, the server device 200 may also carry out reservation process. That is, similar to the apparatus 100 of a hairdresser, the server device 200 carries out registration of reserved time (reservation name) in the facility schedule information stored in the storage unit 203. The information indicating the reservation result carried out by the server device 200 may also be sent from the server device 200 to the apparatus 100 of a hairdresser after performing the reservation, and when a request has received from the apparatus 100 of a hairdresser, may also be sent from the server device 200 to the apparatus 100 of a hairdresser.

### (Eleventh Modification)

The presentation information may also include an image of a map illustrating a position of the shop (for example, beauty parlor).

### (Twelfth Modification)

The service provider is not limited to a hairdresser and may also be, for example, a manicurist, a kimono dresser, an aesthetician, a massage practitioner, and the like. The service providing facility may also be, for example, a restaurant and the like. In that case, facility available time in the facility schedule information is not available time of each service provider but available time of the facility itself (time possible to reserve utilization of the facility).

### (Thirteenth Modification)

While the above embodiment is described taking the case that the service provider provides service to a user at a shop that the service provider belongs to as an example, the mode of providing the service is not limited to this. For example, the mode of providing the service may be in a mode that the service provider travels to a place specified by the user or the service provider and provides service to the user in that place. In this case, for example, it is possible to rephrase the “facility schedule information” illustrated in FIG. 4 into “service provider schedule information”. In addition, for example, it is possible to rephrase the “facility available time” illustrated in FIG. 4 into “available time of service provider”.

In the above description, the modifications in the present embodiment have been described. The above modifications may be combined arbitrarily.

### <Example of Achievement by Computer Program>

In the above description, the embodiments according to the present disclosure have been described in detail with reference to the drawings, and functions of the apparatus 100, the server device 200, and the network 300 described above (hereinafter, referred to as each device) may be achieved by a computer program.

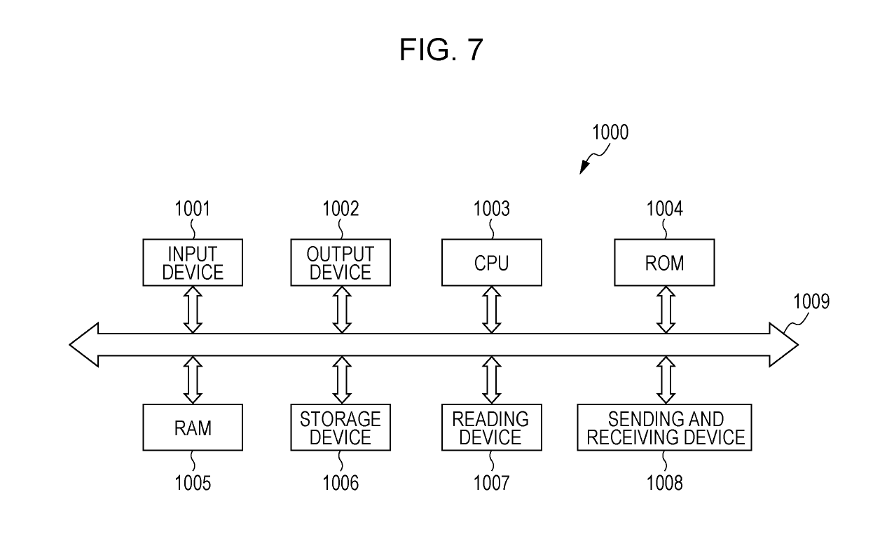

FIG. 7 is a diagram illustrating a hardware configuration of a computer achieving a function of each part by a program. A computer 1000 is provided with an input device 1001, such as input buttons and a touch screen, an output device 1002, such as a display and a speaker, a central processing unit (CPU) 1003, a read only memory (ROM) 1004, a random access memory (RAM) 1005, a storage device 1006, such as a hard disk device and a solid state drive (SSD), a reading device 1007 reading information from a storage medium, such as a digital versatile disk read only memory (DVD-ROM) and a universal serial bus (USB) memory, and a sending and receiving device 1008 carrying out communication via a network, and each part is connected by a bus 1009.

Then, from a storage medium in which a program that achieves a function of each part above, the reading device 1007 reads the program and causes the storage device 1006 to store it. Alternatively, the sending and receiving device 1008 carries out communication with a server device connected to a network and causes the storage device 1006 to store the program to achieve the function of each part above downloaded from the server device.

Then, the CPU 1003 copies the program stored in the storage device 1006 to the RAM 1005 and sequentially reads a command included in the program from the RAM 1005 to execute it, thereby achieving a function of each part above. When performing the program, information obtained by the various processes described in each embodiment is stored in the RAM 1005 or the storage device 1006 for appropriate utilization.

### <Class of Cloud Service>

The technique described in the above embodiments may be achieved by, for example, the following classes of cloud service. However, the classes to achieve the technique described in the above embodiments are not limited to them.

### (Service Class 1: Private Data Center Type)

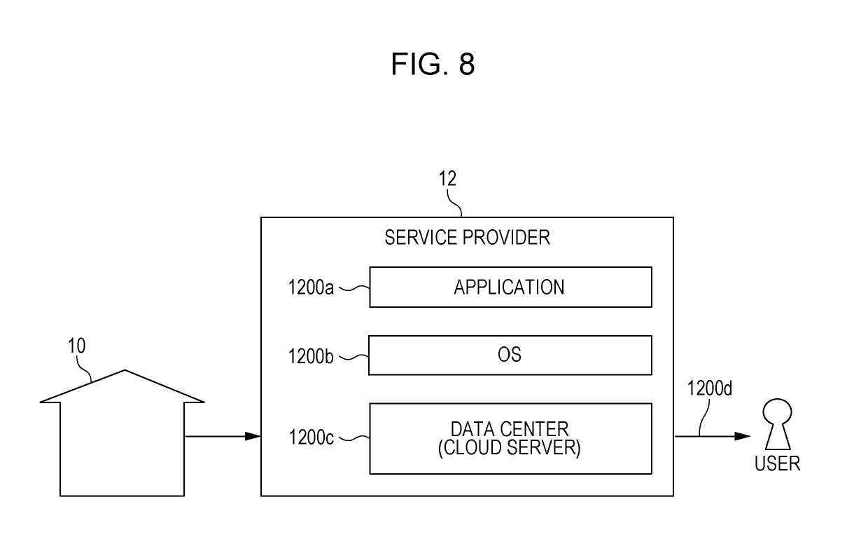

FIG. 8 is a diagram illustrating service class 1 (private data center type). The present class is a class in which the service provider 12 obtains information from the group 10 to provide service to a user. In the present class, the service provider 12 has a function of the data center operating company. That is, a service provider possesses the cloud server 11a to administer big data. Accordingly, there is no data center operating company.

In the present class, the service provider 12 operates and administers a data center (cloud server 11a) (1200c). In addition, the service provider 12 administers an OS (1200b) and an application (1200a). The service provider 12 provides service (1200d) using an OS (1200b) and an application (1200a) administered by the service provider 12.

### (Service Class 2: IaaS Utilization Type)

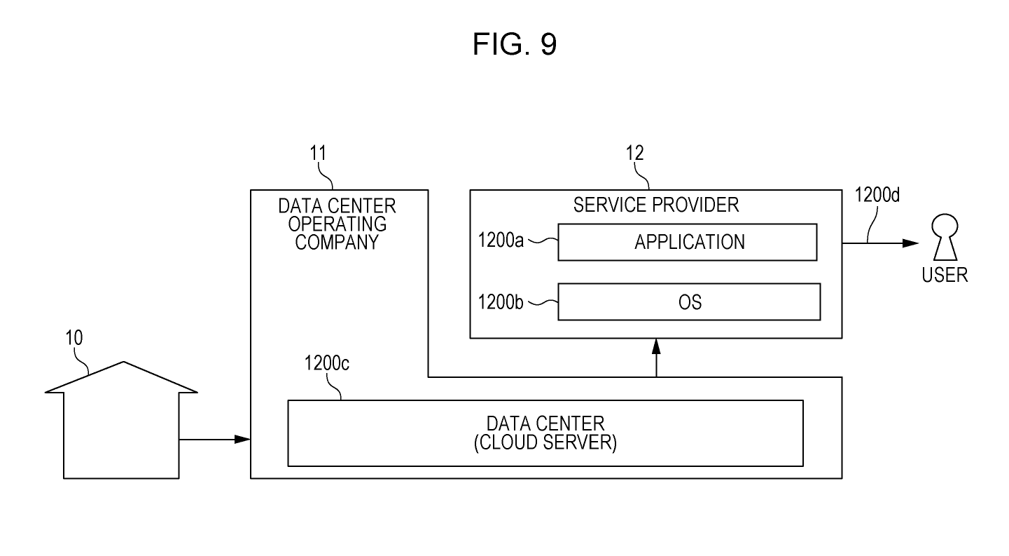

FIG. 9 is a diagram illustrating service class 2 (IaaS utilization type). Here, IaaS is an abbreviation of infrastructure as a service and is a cloud service providing model to provide a backbone itself to construct and drive a computer system as service through the Internet.

In the present class, a data center operating company operates and administers a data center (cloud server 11a) (1200c). In addition, the service provider 12 administers an OS (1200b) and an application (1200a). The service provider 12 provides service using the OS (1200b) and the application (1200a) administered by the service provider 12 (1200d).

### (Service Class 3: PaaS Utilization Type)

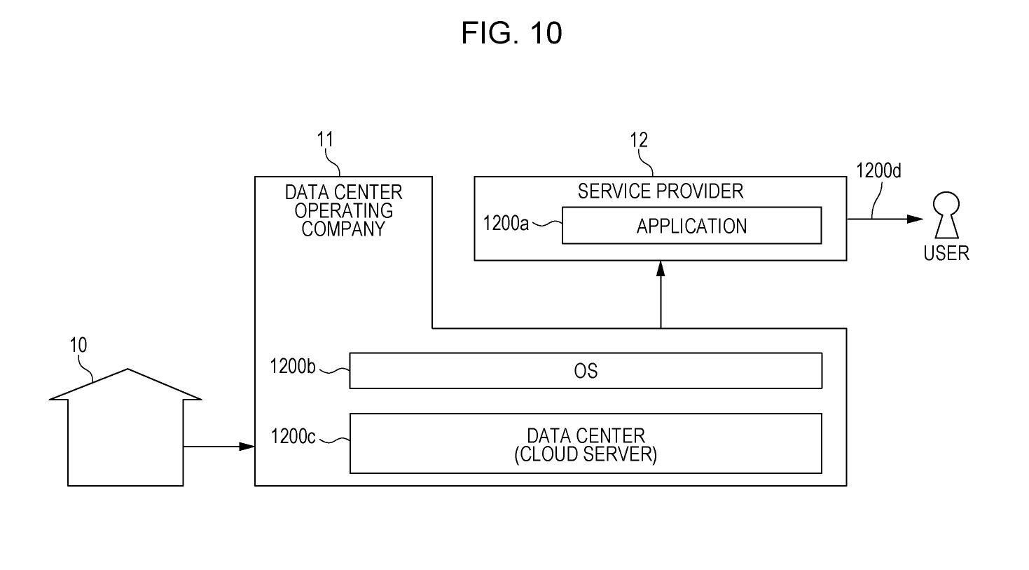

FIG. 10 is a diagram illustrating service class 3 (PaaS utilization type). Here, PaaS is an abbreviation of platform as a service and is a cloud service providing model to provide a platform to be a basis to construct and drive software as service through the Internet.

In the present class, the data center operating company 11 administers an OS (1200b) and operates and administers a data center (cloud server 11a) (1200c). The service provider 12 administers an application (1200a). The service provider 12 provides service using the OS (1200b) administered by the data center operating company and the application (1200a) administered by the service provider 12 (1200d).

### (Service Class 4: SaaS Utilization Type)

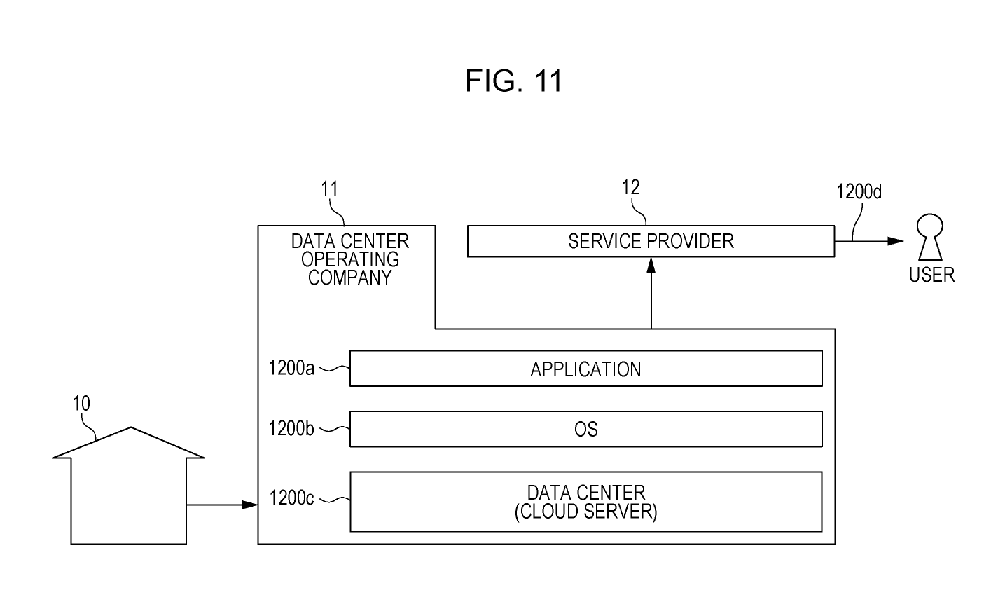

FIG. 11 is a diagram illustrating service class 4 (SaaS utilization type). Here, SaaS is an abbreviation of software as a service. SaaS is, for example, a cloud service providing model having a function that allows a company or an individual (user) not possessing a data center (cloud server) to use an application provided by a platform provider possessing a data center (cloud server) through a network, such as the Internet.

In the present class, the data center operating company 11 administers an application (1200a), administers an OS (1200b), and operates and administers the data center (cloud server 11a) (1200c). In addition, the service provider 12 provides service using the OS (1200b) and the application (1200a) administered by the data center operating company 11 (1200d).

In any class above, it is assumed that the service provider 12 carries out a service providing action. In addition, for example, the service provider or the data center operating company may develop an OS, an application, a database of big data, or the like on their own and may also outsource them to a third party.

The present disclosure is preferred to be used for a reservation assistance method to assist reservation to a service provider by a user.

What is claimed is:

1. A reservation assistance method comprising:
obtaining user schedule information that has a plurality of events of a user registered by time and date, facility schedule information that has available time of a facility providing predetermined service registered therein, and information that indicates correspondence relationship of a predetermined event out of the plurality of events and the facility;
detecting first available time that is before time and date of the predetermined event and also after a current clock time using the user schedule information;
detecting a common time period between the first available time and second available time that is available time of a first facility corresponding to the predetermined event using the facility schedule information and the information that indicates correspondence relationship;
making a provisional reservation of the facility in the common time period for the user;
generating presentation information that is to present the primary reservation to the user; and
sending the presentation information to a terminal device of the user.

2. The reservation assistance method according to claim 1, further comprising:
cancelling the primary reservation when a cancellation request for the primary reservation is received from the terminal device of the user.

3. The reservation assistance method according to claim 1, further comprising:
making non-provisional reservation to the facility in the common time period when an agreement request for the primary reservation is received from the terminal device of the user.

4. The reservation assistance method according to claim 1, further comprising:
obtaining busy time information that illustrates a period of busy time of the facility,
wherein the first available time is detected from the user schedule information except for the period illustrated by the busy time information using the busy time information in the detecting.

5. The reservation assistance method according to claim 1, wherein
the first available time is detected from the user schedule information based on at least any of a day of week or a time period that is specified by the user in the detecting.

6. The reservation assistance method according to claim 1, further comprising:
obtaining first facility schedule information corresponding to a facility that is specified by the user or a facility located in an area that is specified by the user,
wherein
the facility schedule information corresponds to each of the facility or an area where the facility is located, and
the common time period is detected based on the first facility schedule information in the detecting.

7. The reservation assistance method according to claim 1, further comprising:
storing a combination of a first event and a second event; and
obtaining second facility schedule information corresponding to a facility that provides service illustrated by the first event based on the combination, when a third event that is registered in the user schedule information and of a type same as the second event after the current clock time is detected in the detecting,
wherein
the first event that is registered in the user schedule information and indicates that the user has received predetermined service out of the plurality of events before the current clock time is detected in the detecting,
the second event that is registered in the user schedule information and is after time and date of the first event and also before the current dock time is detected in the detecting, and
the common time period is detected using the second facility schedule information and the user schedule information in the detecting.

8. The reservation assistance method according to claim 1, further comprising:
cancelling the primary reservation when the predetermined event is cancelled in the user schedule information.

9. The reservation assistance method according to claim 1, wherein
reservation time and date in the common time period is determined in accordance with the event.

10. The reservation assistance method according to claim 1, wherein
the facility that provides the predetermined service is a beauty parlor.
